(19) United States
(12) Patent Application Publication
(10) Pub. No.: US 2025/0388478 A1
(43) Pub. Date: Dec. 25, 2025

(54) SILICA SOL CONTAINING ADDITIVE, AND METHOD FOR PRODUCING SAME

(71) Applicant: NISSAN CHEMICAL CORPORATION, Tokyo (JP)

(72) Inventors: Hirotake KITAGAWA, Sodegaura-shi (JP); Masashi OHNO, Funabashi-shi (JP); Masaya KASHIHARA, Sodegaura-shi (JP); Samuel MAGUIRE-BOYLE, Houston, TX (US)

(73) Assignee: NISSAN CHEMICAL CORPORATION, Tokyo (JP)

(21) Appl. No.: 18/881,453

(22) PCT Filed: Jul. 5, 2023
(86) PCT No.: PCT/JP2023/024993

§ 371 Date: Jan. 6, 2025

(30) Foreign Application Priority Data
Jul. 5, 2022 (JP) 2022-108332

(51) Int. Cl. C01B 33/148

(52) U.S. Cl. CPC C01B 33/1485; C01P 2002/74

(57) ABSTRACT

An additive-containing silica sol in which a scattering intensity (I) of the additive-containing silica sol as a function of scattering vector (q) determined by a small-angle scattering method using X-rays satisfies Formulae (2) and (3):

$$0.1 \leq ( {I}_{m ax}^{B} ) / ( {I}_{0}^{B} ) - ( {I}_{m ax}^{A} ) / ( {I}_{0}^{A} ) \leq 4.8 \qquad Formula ( 2 )$$

$$1 \leq ( {I}_{m ax}^{A} ) / ( {I}_{0}^{A} ) \qquad For mula ( 3 )$$

where I^{B}₀ and I^{A}₀ are respectively scattering intensities when scattering vector (q) nm⁻¹ of the silica sol is 0.05 if a silica particle concentration in the silica sol before (I^{B}₀) and after (I^{A}₀) an additive is added is 3.5% by mass, and I^{B}ₘₐₓ and I^{A}ₘₐₓ are respectively scattering intensities when the scattering vector (q) nm⁻¹ of the silica sol is a maximum value if the silica particle concentration in the silica sol before (I^{B}ₘₐₓ) and after (I^{A}ₘₐₓ) the additive is added is 3.5% by mass. A HAZE value of the silica sol after storage at 20° C. for 24 hours is lower than before the additive is added.

### TECHNICAL FIELD

The present invention relates to a dispersion of silica particles with high stability based on the electric charge on the surface of particles determined by a small-angle X-ray scattering method.

### BACKGROUND ART

A small-angle scattering method using X-rays is used for structural analysis on the order of several nm to several tens of nm. In the scattering method, samples are irradiated with an energy beam, and the intensity according to the scattered angle is used for evaluation. X-ray scattering occurs when X-rays are used, and when X-rays with a short wavelength are used, scattering from the structure becomes small-angle scattering appearing at small angles of a few degrees or less, and is used for structural analysis.

Light scattering may appear as a variation in the refractive index (dielectric constant), and X-ray scattering may appear as a variation in the electron density.

In small-angle X-ray scattering, the scattering vector q is q=4π sin θ/λ, 2θ is the scattering angle, and λ is the wavelength of incident X-rays. The scattering intensity I as a function of scattering vector q is related to the variation in the electron density in the sample, and allows the shape and surface state of nanoscale structures to be detected.

For example, a semiconductor insulation material which contains silicon atoms, carbon atoms, and oxygen atoms and in which the content of silica particles is 9.5% to 30%, and in small-angle X-ray scattering measurement, a ratio (I₁(q)/I₂(q)) of the scattering intensity I₁(q) when the scattering vector q is 0.1 nm⁻¹ to the scattering intensity I₂(q) when the scattering vector q is 0.2 nm⁻¹ is 1.35 or less has been reported (refer to Patent Document 1).

### PRIOR ART DOCUMENTS

### Patent Documents

Patent Document 1: JP 2014-067829 A

### SUMMARY OF THE INVENTION

### Problem to be Solved by the Invention

Incidentally, in a sol (silica sol) in which silica particles are dispersed in a dispersion medium, an appropriate electrical repulsive force between silica particles is generated due to the electric charge on the surface of the silica particles, and the silica particles can be dispersed in the dispersion medium without aggregation. However, when the dispersion medium is an aqueous medium or organic solvent containing an ionic component, there is a risk of the electrical balance between the electric charge on the surface of the silica particles and the dispersion medium being lost and aggregation occurring.

Thus, there is a demand for a silica sol that can be dispersed without aggregation even if the dispersion medium is an aqueous medium or organic solvent containing an ionic component.

The present invention has been made in view of the above circumstances, and an object of the present invention is to provide a silica sol that can be dispersed without aggregation even if a dispersion medium is an aqueous medium or organic solvent containing an ionic component and a method for producing the silica sol.

In order to achieve the above object, the inventors focused on the fact that, when an additive is added to the silica sol, the electric charge on the surface of the silica particles can be changed, and the electric charge on the surface of the particles affects the dispersion state of the silica particles in the dispersion medium. Thus, they found that a stable silica sol can be obtained when the scattering intensity (I) of the additive-containing silica sol as a function of a specific scattering vector determined by a small-angle scattering method using X-rays satisfies specific conditions, and completed the present invention.

### Means for Solving the Problem

That is, a first aspect of the present invention relates to an additive-containing silica sol in which a scattering intensity (I) of the additive-containing silica sol as a function of scattering vector (q) determined by a small-angle scattering method using X-rays satisfies the following Formula (2) and Formula (3):

$$0.1 \leq ( {I}_{m ax}^{B} ) / ( {I}_{0}^{B} ) - ( {I}_{m ax}^{A} ) / ( {I}_{0}^{A} ) \leq 4.8 \qquad Formula ( 2 )$$

$$1 \leq ( {I}_{m ax}^{A} ) / ( {I}_{0}^{A} ) \qquad For mula ( 3 )$$

in Formula (2) and Formula (3),
I^{B}₀ is a scattering intensity when scattering vector (q) nm⁻¹ of the silica sol is 0.05 if a silica particle concentration in the silica sol before an additive is added is 3.5% by mass,
I^{B}ₘₐₓ is a scattering intensity when the scattering vector (q) nm⁻¹ of the silica sol is a maximum value if the silica particle concentration in the silica sol before the additive is added is 3.5% by mass,
I^{A}₀ is a scattering intensity when the scattering vector (q) nm⁻¹ of the silica sol is 0.05 if the silica particle concentration in the silica sol after the additive is added is 3.5% by mass, and
I^{A}ₘₐₓ is a scattering intensity when the scattering vector (q) nm⁻¹ of the silica sol is a maximum value if the silica particle concentration in the silica sol after the additive is added is 3.5% by mass.

A second aspect relates to the silica sol according to the first aspect,
wherein, regarding a HAZE value of a silica sol using salt water with a salt concentration of 4% by mass as a dispersion medium and with a silica particle concentration of 0.1% by mass, the HAZE value of the silica sol after storage at 20° C. for 24 hours from a time of production is lower than the HAZE value of the silica sol before the additive is added after storage at 20° C. for 24 hours from a time of production.

A third aspect relates to the silica sol according to the first aspect or the second aspect,
wherein, regarding a particle diameter of the silica sol using salt water with a salt concentration of 4% by mass as a dispersion medium and with a silica particle concentration of 0.1% by mass, a ratio of the particle diameter determined by a dynamic light scattering method after storage at 20° C. for 24 hours to the particle diameter determined by the dynamic light scattering method during production is lower than a ratio of the particle diameter determined by the dynamic light scattering method after storage at 20° C. for 24 hours to the particle diameter determined by the dynamic light scattering method during production in the silica sol before the additive is added.

A fourth aspect relates to the silica sol according to any one of the first aspect to the third aspect, wherein the additive is an antioxidant substance.

A fifth aspect relates to the silica sol according to any one of the first aspect to the third aspect,
wherein the additive is a hydrolyzable silane, a sugar, an organic acid or salt of the organic acid, a sulfite, a thiocyanate, a mercapto organic acid or salt of the mercapto organic acid, a surfactant, or a polyhydroxy compound.

A sixth aspect relates to the silica sol according to the fifth aspect,
wherein the hydrolyzable silane has a structure of the following Formula (1):

$${R}_{a}^{1} {Si ( {R}^{2} )}_{4 - a} \qquad Formula ( 1 )$$

(in Formula (1), each of R¹ is an organic group having a cationic functional group or an organic group having an anionic functional group and is bonded to a silicon atom through an Si—C bond, each of R² is an alkoxy group, an acyloxy group, or a halogen atom, and a is an integer of 1 to 3).

A seventh aspect relates to the silica sol according to the sixth aspect,
wherein the cationic functional group is an amino group.

An eighth aspect relates to the silica sol according to the sixth aspect,
wherein the anionic functional group is a glycidoxy group.

A ninth aspect relates to the silica sol according to the fifth aspect,
wherein the sugar is sorbitol, glucose, or arabinose.

A tenth aspect relates to the silica sol according to the fifth aspect,
wherein the organic acid or the salt of the organic acid is gluconic acid, lactic acid, or thioglycolic acid or salt of the gluconic acid, the lactic acid, or the thioglycolic acid.

An eleventh aspect relates to the silica sol according to the fifth aspect,
wherein the sulfite is pyrosulfite.

A twelfth aspect relates to the silica sol according to the fifth aspect,
wherein the thiocyanate is sodium thiocyanate.

A thirteenth aspect relates to the silica sol according to the fifth aspect,
wherein the mercapto organic acid or the salt of the mercapto organic acid is a mercaptoacetic acid or ammonium salt of the mercaptoacetic acid.

A fourteenth aspect relates to the silica sol according to the fifth aspect,
wherein the surfactant is at least one selected from the group consisting of an anionic surfactant, a cationic surfactant, an amphoteric surfactant, and a nonionic surfactant, and is a surfactant including at least an anionic surfactant, a nonionic surfactant, or both of the anionic surfactant and the nonionic surfactant.

A fifteenth aspect relates to the silica sol according to the fifth aspect,
wherein the polyhydroxy compound is ascorbic acid.

A sixteenth aspect relates to the silica sol according to any one of the first aspect to the fifteenth aspect,
wherein the dispersion medium of the silica sol is an aqueous medium with a pH of 1 to 10, salt water with a salt concentration of 0.1 to 4.0% by mass, or an organic solvent.

A seventeenth aspect relates to a method for producing the additive-containing silica sol according to any one of the first aspect to the sixteenth aspect, the method including a step of adding an additive to a silica sol and adjusting a scattering intensity (I) of the additive-containing silica sol as a function of scattering vector (q) determined by a small-angle scattering method using X-rays so that the scattering intensity (I) satisfies the following Formula (2) and Formula (3):

$$0.1 \leq ( {I}_{m ax}^{B} ) / ( {I}_{0}^{B} ) - ( {I}_{m ax}^{A} ) / ( {I}_{0}^{A} ) \leq 4.8 \qquad Formula ( 2 )$$

$$1 \leq ( {I}_{m ax}^{A} ) / ( {I}_{0}^{A} ) \qquad For mula ( 3 )$$

in Formula (2) and Formula (3),
I^{B}₀ is a scattering intensity when scattering vector (q) nm⁻¹ of the silica sol is 0.05 if a silica particle concentration in the silica sol before the additive is added is 3.5% by mass,
I^{B}ₘₐₓ is a scattering intensity when the scattering vector (q) nm⁻¹ of the silica sol is a maximum value if the silica particle concentration in the silica sol before the additive is added is 3.5% by mass,
I^{A}₀ is a scattering intensity when the scattering vector (q) nm⁻¹ of the silica sol is 0.05 if the silica particle concentration in the silica sol after the additive is added is 3.5% by mass, and
I^{A}ₘₐₓ is a scattering intensity when the scattering vector (q) nm⁻¹ of the silica sol is a maximum value if the silica particle concentration in the silica sol after the additive is added is 3.5% by mass.

### Effects of the Invention

According to the present invention, it is possible to provide a silica sol that can be stably dispersed without aggregation even if the dispersion medium is an aqueous medium or organic solvent containing an ionic component and a method for producing the same.

### BRIEF DESCRIPTION OF THE DRAWINGS

FIG. 1 shows the results of small-angle X-ray scattering measurement of silica sols obtained in Example 1, Example 10 and Example 11.

FIG. 2 is an enlarged view of small-angle X-ray scattering measurement of the silica sols obtained in Example 1, Example 10 and Example 11.

FIG. 3 shows the results of small-angle X-ray scattering measurement of silica sols obtained in Comparative Example 1, Comparative Example 2 and Comparative Example 3.

FIG. 4 is an enlarged view of small-angle X-ray scattering measurement of the silica sols obtained in Comparative Example 1, Comparative Example 2 and Comparative Example 3.

FIG. 5 shows the results of small-angle X-ray scattering measurement of silica sols obtained in Example 12 and Comparative Example 2.

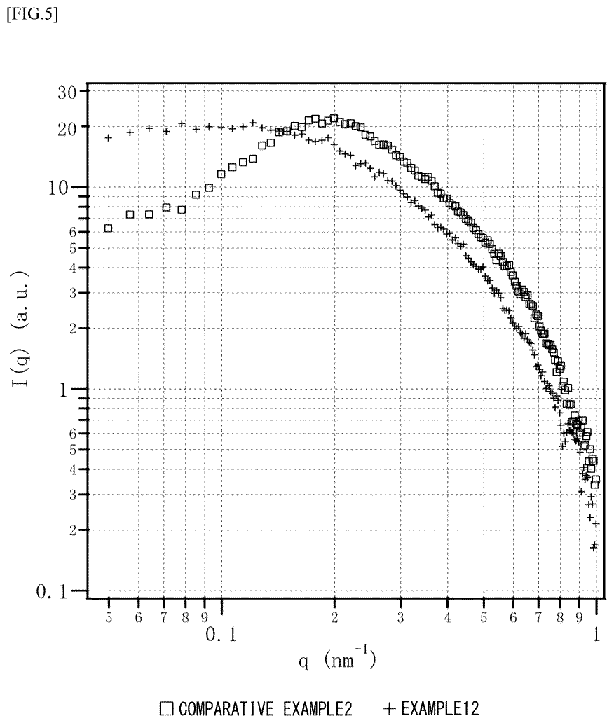

FIG. 6 is an enlarged view of small-angle X-ray scattering measurement of the silica sols obtained in Example 12 and Comparative Example 2.

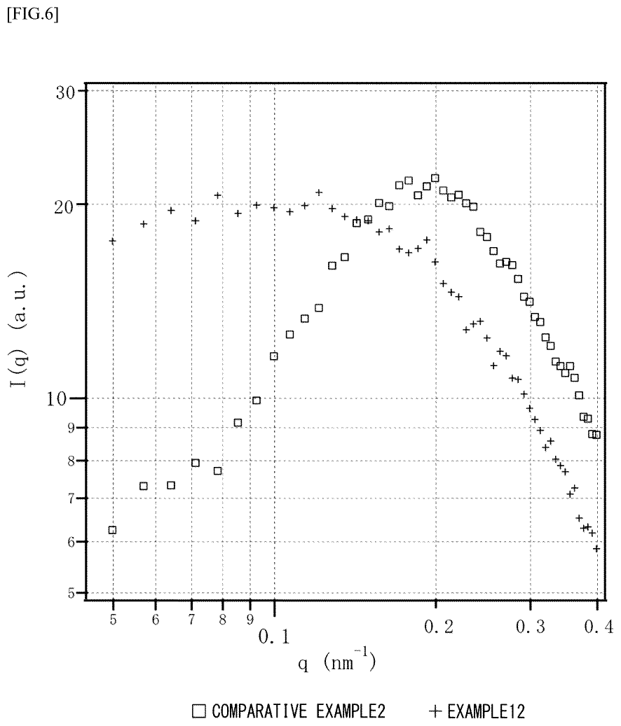

FIG. 7 shows the results of small-angle X-ray scattering measurement of silica sols obtained in Example 13 and Comparative Example 3.

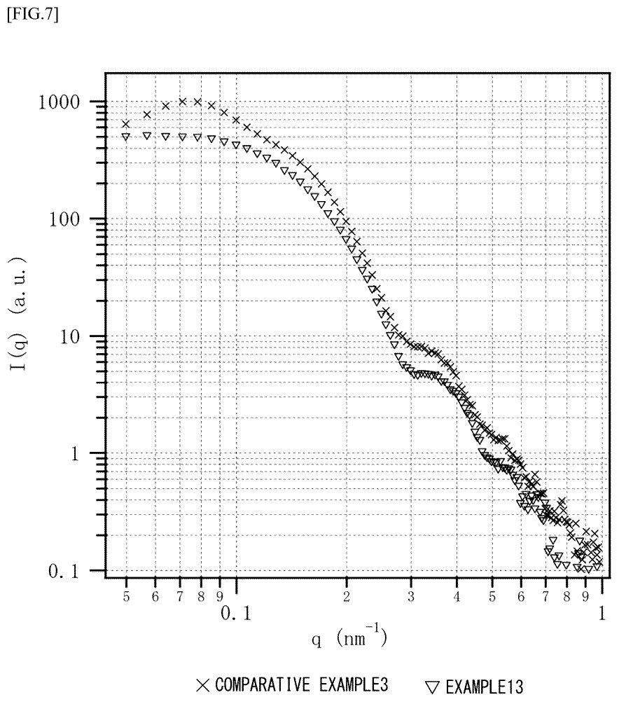

FIG. 8 is an enlarged view of small-angle X-ray scattering measurement of the silica sols obtained in Example 13 and Comparative Example 3.

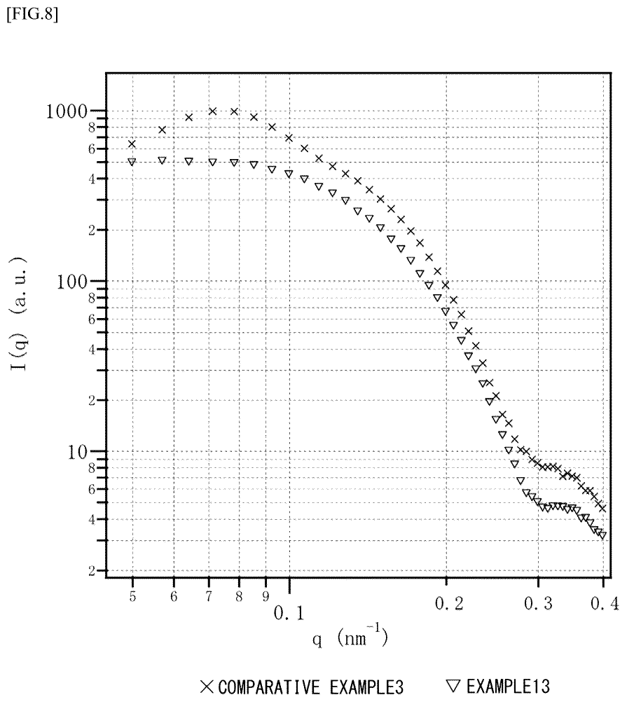

### MODES FOR CARRYING OUT THE INVENTION

The present invention provides an additive-containing silica sol in which a scattering intensity (I) of the additive-containing silica sol as a function of scattering vector (q) determined by a small-angle scattering method using X-rays satisfies the following Formula (2) and Formula (3):

$$0.1 \leq ( {I}_{m ax}^{B} ) / ( {I}_{0}^{B} ) - ( {I}_{m ax}^{A} ) / ( {I}_{0}^{A} ) \leq 4.8 \qquad Formula ( 2 )$$

$$1 \leq ( {I}_{m ax}^{A} ) / ( {I}_{0}^{A} ) \qquad For mula ( 3 )$$

in Formula (2) and Formula (3),
I^{B}₀ is a scattering intensity when scattering vector (q) nm⁻¹ of the silica sol is 0.05 if a silica particle concentration in the silica sol before an additive is added is 3.5% by mass,
I^{B}ₘₐₓ is a scattering intensity when the scattering vector (q) nm⁻¹ of the silica sol is a maximum value if the silica particle concentration in the silica sol before the additive is added is 3.5% by mass,
I^{A}₀ is a scattering intensity when the scattering vector (q) nm⁻¹ of the silica sol is 0.05 if the silica particle concentration in the silica sol after the additive is added is 3.5% by mass, and
I^{A}ₘₐₓ is a scattering intensity when the scattering vector (q) nm⁻¹ of the silica sol is a maximum value if the silica particle concentration in the silica sol after the additive is added is 3.5% by mass.

The scattering vector (q) nm⁻¹ indicates a direction in which a scattering angle 2θ increases from a scattering angle of about 0°, and the measurement range determined by a small-angle scattering method is up to about 5°. In the present invention, the scattering intensity (Iₘₐₓ) when the scattering vector (q) nm⁻¹ is a maximum can be expressed as a ratio to the scattering intensity (I₀) when the scattering vector (q) nm⁻¹ is 0.05.

The scattering intensity (Iₘₐₓ) is a value equal to or larger than the scattering intensity (I₀) when the scattering vector (q) nm⁻¹ is 0.05, and indicates the maximum value among the scattering vectors (q) nm⁻¹, and the scattering intensity (Iₘₐₓ) is a value of the scattering intensity (I) observed when the scattering vector (q) nm⁻¹ is 0.05 or more, which is the scattering vector (q) nm⁻¹ indicating the scattering intensity (I₀). Therefore, the scattering intensity (Iₘₐₓ) may be the same value as the scattering intensity (I₀). Here, the scattering vector (q) nm⁻¹ indicating the scattering intensity (I₀) is derived from the lower measurement limit of a measurement device, and is, for example, 0.05 nm⁻¹, but is not limited to 0.05 nm⁻¹.

As the silica particle concentration in a solution increases, interaction between the particles appears, and order is generated in the silica particle spatial distribution. In such a case, in a small-angle X-ray scattering method, the intensity near the scattering vector of 0 decreases, and a peak appears in the (q) region according to the order, but when the particle concentration is the same, the intensity near the scattering vector of 0 decreases as the electric charge of the particles increases.

Since it is not possible to measure the intensity at the scattering vector of 0 in small-angle X-ray scattering measurement, in the present invention, according to the small-angle X-ray scattering method, when the ratio of the scattering intensities at the scattering vector at the lower measurement limit of the measurement device and at the scattering vector at which a peak corresponding to the order is observed is measured, it is possible to determine the electric charge of the silica particles, and as a result, it is possible to predict the dispersion state in the dispersion medium.

The scattering intensity (I) indicates the electric charge of the silica particles in the additive-containing silica sol, and it was found that, when the electric charge is larger, the scattering intensity in the (I₀) region is lower. Therefore, a smaller (Iₘₐₓ)/(I₀) indicates a smaller electric charge of the silica particles, and a larger (Iₘₐₓ)/(I₀) indicates a larger electric charge of the silica particles. In the present invention, it was found that the stability of the silica sol is high when the (Iₘₐₓ)/(I₀) ratio of the additive-containing silica sol after the additive is added is reduced in a range of 0.1 to 4.8 compared to the (Iₘₐₓ)/(I₀) ratio of the silica sol before the additive is added. Particularly, the dispersion stability is high when the dispersion medium is an aqueous medium with a pH of 1 to 10 or a pH of 1 to 6, an aqueous medium with a pH of 8 to 10, salt water with a salt concentration of 0.1% by mass to 4.0% by mass, or an organic solvent.

The amount of decrease from the (Iₘₐₓ)/(I₀) ratio of the additive-containing silica sol before the additive is added to the (Iₘₐₓ)/(I₀) ratio of the silica sol after the additive is added [corresponding to (I^{B}ₘₐₓ)/(I^{B}₀)−(I^{A}ₘₐₓ)/(I^{A}₀) in Formula (2)] can be set in the range of 0.1 to 4.8, 0.2 to 4.4, 0.8 to 4.4, or 1.7 to 4.4 [where, the (Iₘₐₓ)/(I₀) ratio of the additive-containing silica sol after the additive is added is 1 or more (corresponding to Formula (3)].

In the silica sol used in the present invention, the average particle diameter of the silica particles determined by a dynamic light scattering method (DLS method) is in a range of 5 nm to 200 nm, 5 nm to 150 nm, 5 nm to 100 nm, 5 nm to 80 nm, or 5 nm to 50 nm, and the average primary particle diameter of the silica particles determined by a BET method, a Sears method, or transmission electron microscope observation is in a range of 5 nm to 200 nm, 5 nm to 150 nm, 5 nm to 100 nm, 5 nm to 80 nm, or 5 nm to 50 nm. The average primary particle diameter can be expressed as a value determined by the BET method, the Sears method, or transmission electron microscope observation.

In the silica sol of the present invention, the solid content is 0.1% by mass to 60% by mass, 1% by mass to 55% by mass, or 10% by mass to 55% by mass. Here, the solid content is a content obtained by excluding a dispersion medium component from all components of the silica sol.

When the above scattering intensity ratio is set, for example, regarding the HAZE value of the silica sol using salt water with a salt concentration of 4% by mass as a dispersion medium and with a silica particle concentration of 0.1% by mass, the HAZE value after storage at 20° C. for 24 hours from the time of production can be made lower than the HAZE value of the silica sol before the additive is added after storage at 20° C. for 24 hours from the time of production. In the additive-containing silica sol of the present invention, regarding the HAZE value of the silica sol using salt water with a salt concentration of 4% by mass as a dispersion medium and with a silica particle concentration of 0.1% by mass, the HAZE value (progressive HAZE value) after storage at 20° C. for 24 hours from the time of production is preferably in a range of 0 to 50, 0 to 30, 0 to 10, 0 to 5, 0 to 4, or 0 to 3. When the HAZE value of the silica sol is within the above range, the silica particles contained in the silica sol are unlikely to aggregate when they are dispersed in salt water or an organic solvent, and the silica sol can be used as a transparent dispersion that maintains the dispersion state of the silica particles.

In addition, regarding the particle diameter of the silica sol using salt water with a salt concentration of 4% by mass as a dispersion medium and with a silica particle concentration of 0.1% by mass determined by a dynamic light scattering method, the ratio of the particle diameter determined by a dynamic light scattering method after storage at 20° C. for 24 hours to the particle diameter determined by a dynamic light scattering method during production can be made lower than the ratio of the particle diameter determined by a dynamic light scattering method after storage at 20° C. for 24 hours to the particle diameter determined by a dynamic light scattering method during production in the silica sol before the additive is added. Regarding the particle diameter of the silica sol using salt water with a salt concentration of 4% by mass as a dispersion medium and with a silica particle concentration of 0.1% by mass determined by a dynamic light scattering method, in the additive-containing silica sol of the present invention, the value (progressive DLS diameter) after storage for 24 hours relative to the initial value (initial DLS diameter) within 12 hours from the time of production (DLS change) is preferably in a range of 0.5 to 5, 0.5 to 4, 0.5 to 3, 0.5 to 2, 0.5 to 1.8, 0.5 to 1.5, 0.8 to 4, or 0.8 to 1.8 times. When the value of the silica sol is within the above range, since the silica particles contained in the silica sol are less likely to aggregate when they are dispersed in salt water or an organic solvent, the silica sol can be used with a large number of silica particles and a large specific surface area.

Examples of silica sols used in the present invention include 1) a silica sol obtained by using water glass as a raw material, removing alkali metal ions by cation exchange and then performing heating, 2) a silica sol obtained by condensing a silane hydrolysate obtained by hydrolyzing a hydrolyzable silane compound, 3) a silica sol obtained by dispersing gas phase fumed silica obtained by hydrolyzing gasified tetrachlorosilane with hydrogen and oxygen in a medium, and 4) a silica sol obtained by re-dispersing a precipitated silica obtained by washing a precipitate obtained by reacting an alkaline silicate aqueous solution with an acid in an aqueous medium.

The silica sol of the present invention can contain an antioxidant substance as an additive. In addition, the silica sol of the present invention can contain, as an additive, a hydrolyzable silane, a sugar, an organic acid or its salt, a sulfite, a thiocyanate, a mercapto organic acid or its salt, a surfactant, or a polyhydroxy compound.

When the hydrolyzable silane is added to the silica sol, some cover the surface of the silica particles and others are present as a hydrolysate in the medium or on the surface of the silica particles. In the present invention, both cases can be present in a mixed state.

The hydrolyzable silane used in the present invention can have the structure of General Formula (1).

$${R}_{a}^{1} {Si ( {R}^{2} )}_{4 - a} \qquad Formula ( 1 )$$

(in Formula (1), each of R¹ is an organic group having a cationic functional group or an organic group having an anionic functional group and is bonded to a silicon atom through an Si—C bond, each of R² is an alkoxy group, an acyloxy group, or a halogen atom, and a is an integer of 1 to 3).

The organic group having a cationic group is an organic group having an amino group, and examples of amino groups include a primary amino group, a secondary amino group, and a tertiary amino group. Examples of these organic groups having a cationic group include N-2-(aminoethyl)-3-aminopropyl group, 3-aminopropyl group, N-(1,3-dimethyl-butylidene)propyl group, N-phenyl-3-aminopropyl group, and 3-ureidopropyl group. Examples of these silane compounds include N-2-(aminoethyl)-3-aminopropylmethyldimethoxysilane, N-2-(aminoethyl)-3-aminopropyltrimethoxysilane, 3-aminopropyltrimethoxysilane, 3-aminopropyltriethoxysilane, 3-triethoxysilyl-N-(1,3-dimethyl-butylidene)propylamine, N-phenyl-3-aminopropyltrimethoxysilane, and 3-ureidopropyltrialkoxysilane.

Examples of organic groups having an anionic group include organic groups having a 2-(3,4-epoxycyclohexyl)ethyl group, a 3-glycidoxypropyl group, a propylsuccinic anhydride group or the like. Examples of these silane compounds include 2-(3,4-epoxycyclohexyl)ethyltrimethoxysilane, 3-glycidoxypropylmethyldimethoxysilane, 3-glycidoxypropyltrimethoxysilane, 3-glycidoxypropylmethyldiethoxysilane, 3-glycidoxypropyltriethoxysilane, and 3-trimethoxysilylpropylsuccinic anhydride.

The sugars used in the present invention include monosaccharides and polysaccharides, and examples of monosaccharides include triose, tetrose, pentose, hexose, heptose, arabinose, and glucose, and examples of polysaccharides include disaccharides, trisaccharides, and tetrasaccharides. Among these, examples of monosaccharides include arabinose and glucose, and further include sorbitol obtained by catalytic reduction of glucose.

The organic acid or its salt used in the present invention is an organic acid having a carboxy group or a sulfonate group or its salt, and particularly preferably an organic acid having a carboxy group or its salt. These organic acid salts are salts of alkali metals such as sodium and potassium or ammonium salts. They may further have a hydroxy group or a thiol group as an antioxidant functional group. Examples of organic acids include citric acid, acetic acid, malic acid, gluconic acid, lactic acid, succinic acid, tartaric acid, butyric acid, fumaric acid, propionic acid, formic acid, and thioglycolic acid, and hydroxy carboxylic acids are particularly preferable, and examples thereof include citric acid, malic acid, lactic acid, tartaric acid, and thioglycolic acid.

The sulfite used in the present invention is a pyrosulfite, which has an antioxidant effect. Examples of salts include sodium salts, potassium salts, and ammonium salts.

The thiocyanate used in the present invention can be sodium thiocyanate.

The mercapto organic acid or its salt used in the present invention can be a mercaptoacetic acid or its ammonium salt.

Examples of surfactants used in the present invention include an anionic surfactant, a cationic surfactant, a nonionic surfactant, and an amphoteric surfactant.

The surfactant is at least one selected from the group consisting of an anionic surfactant, a cationic surfactant, an amphoteric surfactant, and a nonionic surfactant, and a surfactant including at least an anionic surfactant, a nonionic surfactant, or both can be used.

Examples of anionic surfactants include sodium salts and potassium salts of fatty acids, alkylbenzene sulfonates, higher alcohol sulfate ester salts, polyoxyethylene alkyl ether sulfates, α-sulfofatty acid esters, α-olefin sulfonates, monoalkyl phosphate ester salts, and alkanesulfonates.

The alkylbenzene sulfonates have, for example, sodium ions, potassium ions and lithium ions as counter ions. Specific examples of alkylbenzene sulfonates include sodium (C₁₀₋₁₆) alkylbenzene sulfonate, potassium (C₁₀₋₁₆) alkylbenzene sulfonate, and sodium alkylnaphthalene sulfonate.

Examples of higher alcohol sulfate ester salts include sodium dodecyl sulfate (sodium lauryl sulfate) having a carbon atom number of 12, triethanolamine lauryl sulfate, and triethanolammonium lauryl sulfate.

Examples of polyoxyethylene alkyl ether sulfates include sodium polyoxyethylene styrenated phenyl ether sulfate, polyoxyethylene styrenated phenyl ether ammonium sulfate, polyoxyethylene decyl ether sodium sulfate, polyoxyethylene decyl ether ammonium sulfate, sodium polyoxyethylene lauryl ether sulfate, polyoxyethylene lauryl ether ammonium sulfate, sodium polyoxyethylene tridecyl ether sulfate, and sodium polyoxyethylene oleyl cetyl ether sulfate.

Examples of α-olefin sulfonates include sodium α-olefin sulfonate.

Examples of alkanesulfonates include sodium 2-ethylhexyl sulfate.

Examples of cationic surfactants include alkyltrimethylammonium salts, dialkyldimethylammonium salts, alkyldimethylbenzyl ammonium salts, and amine salt agents.

The alkyltrimethylammonium salts are quaternary ammonium salts, and have, for example, chloride ions or bromide ions as counter ions. Specific examples of alkyltrimethylammonium salts include dodecyltrimethylammonium chloride, cetyltrimethylammonium chloride, coconut alkyl trimethyl ammonium chloride, and alkyl (C₁₆₋₁₈) trimethyl ammonium chloride.

The dialkyldimethylammonium salts have two lipophilic main chains and two methyl groups, and examples thereof include didecyldimethylammonium chloride, di(cocoalkyl) dimethyl ammonium chloride, dihydrogenated tallow alkyl dimethyl ammonium chloride, and dialkyl (C₁₄₋₁₈) dimethylammonium chloride.

The alkyldimethylbenzyl ammonium salts are quaternary ammonium salts (benzalkonium chloride) having one lipophilic main chain, two methyl groups, and a benzyl group, and examples thereof include alkyl (C₈₋₁₈) dimethylbenzylammonium chloride.

The amine salt agents are compounds in which hydrogen atoms of ammonia are substituted with one or more hydrocarbon groups, and examples thereof include N-methylbishydroxyethylamine fatty acid ester hydrochloride.

Examples of amphoteric surfactants include N-alkyl-β-alanine type alkylamino fatty acid salts, alkyl carboxybetaine type alkylbetaines, and N,N-dimethyldodecylamine oxide type alkylamine oxides.

Examples of these include lauryl betaine, stearyl betaine, 2-alkyl-N-carboxymethyl-N-hydroxyethyl imidazolinium betaine, and lauryl dimethylamine oxides.

The nonionic surfactant is selected from the group consisting of polyoxyethylene alkyl ether, polyoxyethylene alkyl phenyl ether, alkylglucoside, polyoxyethylene fatty acid ester, sucrose fatty acid ester, sorbitan fatty acid ester, polyoxyethylene sorbitan fatty acid ester, and fatty acid alkanolamide.

Examples of polyoxyethylene alkyl ethers include polyoxyethylene dodecyl ether (polyoxyethylene lauryl ether), polyoxyalkylene lauryl ether, polyoxyethylene tridecyl ether, polyoxyalkylene tridecyl ether, polyoxyethylene myristyl ether, polyoxyethylene cetyl ether, polyoxyethylene oleyl ether, polyoxyethylene stearyl ether, polyoxyethylene behenyl ether, polyoxyethylene-2-ethylhexyl ether, and polyoxyethylene isodecyl ether.

Examples of polyoxyethylene alkyl phenyl ethers include plyoxyethylene styrenated phenyl ether, polyoxyethylene nonylphenyl ether, polyoxyethylene distyrenated phenyl ether, and polyoxyethylene tribenzyl phenyl ether.

Examples of alkylglucosides include decyl glucoside and lauryl glucoside.

Examples of polyoxyethylene fatty acid esters include polyoxyethylene monolaurate, polyoxyethylene monostearate, polyoxyethylene monooleate, polyethylene glycol distearate, polyethylene glycol diolate, and polypropylene glycol diolate.

Examples of sucrose fatty acid esters include sucrose palmitate, sucrose stearate, sucrose laurate, sucrose erucate, and sucrose oleate.

Examples of sorbitan fatty acid esters include sorbitan monocaprylate, sorbitan monolaurate, sorbitan monomyristate, sorbitan monopalmitate, sorbitan monostearate, sorbitan distearate, sorbitan tristearate, sorbitan monooleate, sorbitan trioleate, sorbitan monosesquioleate, and ethylene oxide adducts thereof.

Examples of polyoxyethylene sorbitan fatty acid esters include polyoxyethylene sorbitan monolaurate, polyoxyethylene sorbitan monopalmitate, polyoxyethylene sorbitan monostearate, polyoxyethylene sorbitan tristearate, polyoxyethylene sorbitan monooleate, polyoxyethylene sorbitan trioleate, and polyoxyethylene sorbitan triisostearate.

In addition, examples of fatty acid alkanolamides include coconut oil fatty acid diethanolamide, tallow acid diethanolamide, lauric acid diethanolamide, and oleic acid diethanolamide.

In addition, polyoxyethylene polyoxypropylene glycol, polyoxyalkyl ethers such as polyoxyethylene fatty acid ester or polyoxyalkyl glycol, polyoxyethylene hydrogenated castor oil ether, sorbitan fatty acid ester alkyl ether, alkyl polyglucoside and the like can also be used.

In the present invention, a polyhydroxy compound can be used as the additive. The polyhydroxy compound has an antioxidant effect. The polyhydroxy compound has a structure in which a plurality of hydroxyl groups are bonded to a linear or cyclic hydrocarbon structure, and can contain a diol, a triol, or its structure in repeating units. A representative example is ascorbic acid, and its derivatives, glyceryl ascorbic acid and the like can also be used.

In the present invention, the dispersion medium of the silica sol containing an additive is preferably a highly ionic dispersion medium or a highly polar organic solvent. Examples thereof include an aqueous medium with a pH of 1 to 10 or a pH of 1 to 6, an aqueous medium with a pH of 8 to 10, and seawater which is salt water with a salt concentration of 0.1% by mass to 4.0% by mass. Here, an organic solvent, particularly, an organic solvent with high polarity, may be also exemplified,

The polar organic solvent may be a protic solvent or an aprotic solvent. The protic polar solvent is a polar solvent that readily donates protons and has a high dielectric constant. The aprotic polar organic solvent has a dielectric constant. Examples of polar organic solvents include organic solvents such as dimethylformamide, N-methylpyrrolidone, dimethylsulfoxide, methanol, ethanol, and acetic acid.

In the present invention, the additive-containing silica sol of the present invention can be produced by a method including a step of adding an additive to a silica sol and adjusting a scattering intensity (I) of the additive-containing silica sol as a function of scattering vector (q) determined by a small-angle scattering method using X-rays so that the scattering intensity (I) satisfies the following Formula (2) and Formula (3).

$$0.1 \leq ( {I}_{m ax}^{B} ) / ( {I}_{0}^{B} ) - ( {I}_{m ax}^{A} ) / ( {I}_{0}^{A} ) \leq 4.8 \qquad Formula ( 2 )$$

$$1 \leq ( {I}_{m ax}^{A} ) / ( {I}_{0}^{A} ) \qquad For mula ( 3 )$$

in Formula (2) and Formula (3),
I^{B}₀ is a scattering intensity when scattering vector (q) nm⁻¹ of the silica sol is 0.05 if a silica particle concentration in the silica sol before the additive is added is 3.5% by mass,
I^{B}ₘₐₓ is a scattering intensity when scattering vector (q) nm⁻¹ of the silica sol is a maximum value if a silica particle concentration in the silica sol before the additive is added is 3.5% by mass,
I^{A}₀ is a scattering intensity when the scattering vector (q) nm⁻¹ of the silica sol is 0.05 if the silica particle concentration in the silica sol after the additive is added is 3.5% by mass, and
I^{A}ₘₐₓ is a scattering intensity when the scattering vector (q) nm⁻¹ of the silica sol is a maximum value if the silica particle concentration in the silica sol after the additive is added is 3.5% by mass.

When a step of adding an additive to a silica sol and performing adjustment so that Formula (2) and Formula (3) are satisfied is provided, the additive-containing silica particles can be stably dispersed in the dispersion medium.

The content of the additive may be a set value for the aqueous medium of the silica sol or may be a value after changing the solvent to an aqueous medium with a pH of 1 to 10, for example, a pH of 1 to 6, an aqueous medium with a pH of 8 to 10, salt water with a salt concentration of 0.1% by mass to 4.0% by mass, or an organic solvent.

The additive-containing silica sol of the present invention can be used for an adhesive, a release agent, a semiconductor sealant, an LED sealant, a paint, a film internal additive, a hard coat agent, a photoresist material, a printing ink, a detergent, a cleaner, an additive for various resins, an insulating composition, an antirust agent, a lubricant oil, a metal processing oil, a coating agent for film, a peeling agent, a well treatment agent and the like.

### EXAMPLES

Hereinafter, the present invention will be described in more detail with reference to examples, but the present invention is not limited to the following examples. Here, in the following examples and comparative examples, devices and conditions used for preparing samples and analyzing physical properties are as follows.

### (Small-Angle X-Ray Scattering Device)

A NANO-Viewer (product name, commercially available from Rigaku Corporation) was used.

### (DLS Average Particle Diameter (Particle Diameter Determined by Dynamic Light Scattering Method))

A dynamic light scattering particle diameter measuring device, Zetasizer Nano (product name, commercially available from Spectris Co., Ltd., Malvern Division) was used.

### (pH Measurement)

A pH meter (commercially available from DKK-TOA Corporation) was used.

### (HAZE Value)

A HAZE meter (product name NDH5000, commercially available from Nippon Denshoku Industries Co., Ltd.) was used. The HAZE value is a value indicating the cloudiness or turbidity of a silica sol when visible light is emitted, and is expressed as a ratio of a total light transmittance T.T including both a parallel component P.T and a diffuse component, and a diffuse transmittance DIF excluding the parallel component.

$$HAZE value = DIF / T . T \times 100$$

### (SAXS Measurement Conditions for Small-Angle X-Ray Scattering Spectrum)

Cu-Kα rays were used as an X-ray source, X-rays were irradiated to a sample sealed in a capillary, and the scattered X-rays were detected using a two-dimensional detector (product name PILATUS 200k, commercially available from Dektris).

The distance from the sample to the detector was 1,200 mm. The obtained two-dimensional image was subjected to a one-dimensional processing using a 2DP (commercially available from Rigaku Corporation), and the scattering vector (q) and the scattering intensity (I) were extracted.

### (Evaluation of Salt Resistance)

After a stirring bar was placed in a 200 ml styrene bottle, each of chemical liquids produced in Example 1 to Example 13 or Comparative Example 1 to Comparative Example 3 was diluted with salt water (artificial seawater) and pure water so that the silica concentration was 0.1% by mass. For example, in Example 4, 0.56 g of the chemical liquid was added and stirred with a magnetic stirrer. While stirring with the magnetic stirrer, 10.56 g of pure water and 88.89 g of salt water with a salt concentration of 4.5% by mass were added, and stirred for 1 hour. This sample was used as a brine test sample (salt water evaluation sample) for evaluating the heat resistance and salt resistance of the chemical liquid under a salt concentration of 4% by mass. The main component of the salt was sodium chloride, and also contained calcium chloride, magnesium chloride, magnesium sulfate, sodium bicarbonate or the like.

100 g of the brine test sample was placed in a 200 ml sealable styrene container, and after sealing, the sample was left in the styrene container at 20° C. and held for 24 hours, and the appearance of the brine test sample, the DLS average particle diameter of the aqueous silica sol (silica particles) in the sample, and the HAZE value were then evaluated.

For example, in Example 12, 0.97 g of the chemical liquid was added and stirred with a magnetic stirrer. While stirring with the magnetic stirrer, 10.14 g of pure water and 88.89 g of salt water with a salt concentration of 4.5% by mass were added and stirred for 1 hour. This sample was used as a brine test sample (salt water evaluation sample) for evaluating the heat resistance and salt resistance of the chemical liquid under a salt concentration of 4% by mass. The main component of the salt was sodium chloride. 100 g of the brine test sample was placed in a 200 ml sealable styrene container, and after sealing, the sample was left in the styrene container at 20° C. and held for 24 hours, and the appearance of the brine test sample, the DLS average particle diameter of the aqueous silica sol (silica particles) in the sample, and the HAZE value were then evaluated.

For example, in Example 13, 0.26 g of the chemical liquid was added and stirred with a magnetic stirrer. While stirring with the magnetic stirrer, 10.85 g of pure water and 88.89 g of salt water with a salt concentration of 4.5% by mass were added and stirred for 1 hour. This sample was used as a brine test sample (salt water evaluation sample) for evaluating the heat resistance and salt resistance of the chemical liquid under a salt concentration of 4% by mass. The main component of the salt was sodium chloride. 100 g of the brine test sample was placed in a 200 ml sealable styrene container, and after sealing, the sample was left in the styrene container at 20° C. and held for 24 hours, and the appearance of the brine test sample, the DLS average particle diameter of the aqueous silica sol (silica particles) in the sample, and the HAZE value were then evaluated.

As an aqueous silica sol (1), a silica sol (with a pH of 2.6, a silica concentration of 20.0% by mass, an average primary particle diameter (determined by a BET method) of 12.0 nm, and an average particle diameter (determined by a DLS method) of 17 nm, commercially available from Nissan Chemical Corporation) was prepared.

As an aqueous silica sol (2), a silica sol (with a pH of 2.7, a silica concentration of 10.5% by mass, an average primary particle diameter (determined by a Sears method) of 5.0 nm, and an average particle diameter (determined by a DLS method) of 9 nm, commercially available from Nissan Chemical Corporation) was prepared.

As an aqueous silica sol (3), a silica sol (with a pH of 2.4, a silica concentration of 40.5% by mass, an average primary particle diameter (determined by a BET method) of 22.0 nm, and an average particle diameter (determined by a DLS method) of 35 nm, commercially available from Nissan Chemical Corporation) was prepared.

### Example 1

After 1,200 g of the aqueous silica sol (1) and a magnetic stirring bar were placed in a 2,000 mL glass eggplant flask, while stirring with a magnetic stirrer, 191.0 g of 3-glycidoxypropyltrimethoxysilane (Dynasylan (product name) GLYMO, commercially available from Evonik Industries AG) was added so that the mass ratio of the silane compound to the silica (colloidal silica particles) in the aqueous silica sol was 0.80. Subsequently, a cooling pipe through which tap water flowed was installed at the top of the eggplant flask, and while refluxing, the aqueous sol was heated to 60° C. and held at 60° C. for 4 hours and then cooled. After cooling to room temperature, the aqueous sol was taken out. This aqueous silica sol was placed in a crucible and heated on a hot plate at 100° C., the solvent was removed and then baked in an electric furnace at 1,000° C. for 30 minutes, and the resulting baking residue was calculated as the silica solid content.

1,391.0 g of an aqueous silica sol of Example 1 subjected to a surface treatment with a silane compound was obtained (the mass ratio of the silane compound to the silica in the aqueous silica sol=0.80, silica solid content=21.2% by mass, pH=3.1, electrical conductivity=353 S/cm, and DLS average particle diameter=23.2 nm).

### Example 2

A stirring bar was placed in a 120 mL styrene bottle, and while stirring with a magnetic stirrer, 101.0 g of the aqueous silica sol produced in Example 1 was added. 15 g of pure water was added, 0.96 g of sodium α-olefin sulfonate (Neogen (product name) AO-90, an active component of 100% by mass, commercially available from DKS Co., Ltd.) as an anionic surfactant was then added, and the mixture was stirred until it was completely dissolved. Subsequently, 0.36 g of sodium dodecyl sulfate (SINOLIN (product name) 90TK-T, an active component of 97% by mass, commercially available from New Japan Chemical Co., Ltd.) as an anionic surfactant was added and the mixture was stirred until it was completely dissolved. Subsequently, as a nonionic surfactant, 2.07 g of polyoxyethylene styrenated phenyl ether with HLB=14.3 (Noigen (product name) EA-157, an active component of 100% by mass, commercially available from DKS Co., Ltd.) diluted with pure water to make 70% by mass of an active component was added to produce a chemical liquid of Example 2. In this case, the mass ratio of the anionic surfactant to the silica solid content of the aqueous silica sol was 0.03, and the mass ratio of the nonionic surfactant to the silica solid content of the aqueous silica sol was 0.07.

### Example 3

After 1,000 g of the aqueous silica sol (1) and a magnetic stirring bar were placed in a 2,000 mL glass eggplant flask, while stirring with a magnetic stirrer, 121.36 g of lactic acid (an active component of 85-92% by mass, commercially available from Kanto Chemical Co., Inc.) was added, and 149.12 g of 4-aminopropyltriethoxysilane (product name KBE-903, commercially available from Shin-Etsu Chemical Co., Ltd.) was then added. Subsequently, a cooling pipe through which tap water flowed was installed at the top of the eggplant flask, and while refluxing, the aqueous sol was heated to 60° C. and held at 60° C. for 4 hours and then cooled. After cooling to room temperature, the aqueous sol was taken out.

1,270.48 g of an aqueous silica sol of Example 3 subjected to a surface treatment with a silane compound was obtained (silica solid content=19.36% by mass, pH=3.93, electrical conductivity=697 S/cm, and DLS average particle diameter=21.79 nm).

### Example 4

A stirring bar was placed in a 120 mL styrene bottle, 9.15 g of pure water and 87.76 g of the aqueous silica sol (1) were added and stirred with a magnetic stirrer. Subsequently, while stirring with the magnetic stirrer, 3.09 g of ascorbic acid (an active component of 97% by mass, commercially available from Junsei Chemical Co., Ltd.) was added, and the mixture was stirred until it was completely dissolved to produce a chemical liquid of Example 4.

### Example 5

A stirring bar was placed in a 120 mL styrene bottle, 9.15 g of pure water and 87.76 g of the aqueous silica sol (1) were added and stirred with a magnetic stirrer. Subsequently, while stirring with the magnetic stirrer, 3.09 g of sodium pyrosulfife (an active component of 97% by mass, commercially available from FUJIFILM Wako Pure Chemical Corporation) was added, and the mixture was stirred until it was completely dissolved to produce a chemical liquid of Example 5.

### Example 6

A stirring bar was placed in a 120 mL styrene bottle, 6.24 g of pure water and 87.76 g of the aqueous silica sol (1) were added and stirred with a magnetic stirrer. Subsequently, while stirring with the magnetic stirrer, 5.99 g of gluconic acid (an active component of 50% by mass, commercially available from FUJIFILM Wako Pure Chemical Corporation) was added, and the mixture was stirred until it was completely dissolved to produce a chemical liquid of Example 6.

### Example 7

A stirring bar was placed in a 120 mL styrene bottle, 9.15 g of pure water and 87.76 g of the aqueous silica sol (1) were added and stirred with a magnetic stirrer. Subsequently, while stirring with the magnetic stirrer, 3.09 g of sodium dodecyl sulfate (SINOLIN (product name) 90TK-T, an active component of 97% by mass, commercially available from New Japan Chemical Co., Ltd.) was added, and the mixture was stirred until it was completely dissolved to produce a chemical liquid of Example 7.

### Example 8

A stirring bar was placed in a 120 mL styrene bottle, 9.24 g of pure water and 87.76 g of the aqueous silica sol (1) were added and stirred with a magnetic stirrer. Subsequently, while stirring with the magnetic stirrer, 2.99 g of glucose (product name: Nisshoku anhydrous crystalline glucose #300, an active component of 100% by mass, commercially available from Nihon Shokuhin Kako Co., Ltd.) was added, and the mixture was stirred until it was completely dissolved to produce a chemical liquid of Example 8.

### Example 9

A stirring bar was placed in a 120 mL styrene bottle, 9.15 g of pure water and 87.76 g of the aqueous silica sol (1) were added and stirred with a magnetic stirrer. Subsequently, while stirring with the magnetic stirrer, 3.09 g of sodium sulfite (an active component of 97% by mass, commercially available from FUJIFILM Wako Pure Chemical Corporation) was added, and the mixture was stirred until it was completely dissolved to produce a chemical liquid of Example 9.

### Example 10

A stirring bar was placed in a 120 mL styrene bottle, 9.24 g of pure water and 87.76 g of the aqueous silica sol (1) were added and stirred with a magnetic stirrer. Subsequently, while stirring with the magnetic stirrer, 2.99 g of sodium thiocyanate (an active component of 100% by mass, commercially available from FUJIFILM Wako Pure Chemical Corporation) was added, and the mixture was stirred until it was completely dissolved to produce a chemical liquid of Example 10.

### Example 11

A stirring bar was placed in a 120 mL styrene bottle, 6.24 g of pure water and 87.76 g of the aqueous silica sol (1) were added and stirred with a magnetic stirrer. Subsequently, while stirring with the magnetic stirrer, 5.99 g of ammonium mercaptoacetate (an active component of 50% by mass, commercially available from FUJIFILM Wako Pure Chemical Corporation) was added, and the mixture was stirred until it was completely dissolved to produce a chemical liquid of Example 11.

### Example 12

A stirring bar was placed in a 120 mL styrene bottle, 98.23 g of the aqueous silica sol (2) was added and stirred with a magnetic stirrer. Subsequently, while stirring with the magnetic stirrer, 1.77 g of ascorbic acid (an active component of 97% by mass, commercially available from Junsei Chemical Co., Ltd.) was added, and the mixture was stirred until it was completely dissolved to produce a chemical liquid of Example 12.

### Example 13

A stirring bar was placed in a 120 mL styrene bottle, 93.5 g of the aqueous silica sol (3) was added and stirred with a magnetic stirrer. Subsequently, while stirring with the magnetic stirrer, 6.50 g of ascorbic acid (an active component of 97% by mass, commercially available from Junsei Chemical Co., Ltd.) was added, and the mixture was stirred until it was completely dissolved to produce a chemical liquid of Example 13.

### Comparative Example 1

The aqueous silica sol (1) was used.

### Comparative Example 2

The aqueous silica sol (2) was used.

### Comparative Example 3

The aqueous silica sol (3) was used.

### (Evaluation of Silica Sol)

Table 1 to Table 4 show I^{A}₀, I^{A}ₘₐₓ, I^{B}₀ and I^{B}ₘₐₓ for Example 1 to Example 13 and Comparative Example 1 to Comparative Example 3.

I^{B}₀ is a scattering intensity when the scattering vector (q) nm⁻¹ of the silica sol is 0.05 if the silica particle concentration in the silica sol before the additive is added is 3.5% by mass,

I^{B}ₘₐₓ is a scattering intensity when the scattering vector (q) nm⁻¹ of the silica sol is a maximum value if the silica particle concentration in the silica sol before the additive is added is 3.5% by mass,

I^{A}₀ is a scattering intensity when the scattering vector (q) nm⁻¹ of the silica sol is 0.05 if the silica particle concentration in the silica sol after the additive is added is 3.5% by mass, and

I^{A}ₘₐₓ is a scattering intensity when the scattering vector (q) nm⁻¹ of the silica sol is a maximum value if the silica particle concentration in the silica sol after the additive is added is 3.5% by mass.

Here, Table 1 to Table 3 show values obtained by subtracting the (I^{A}ₘₐₓ)/(I^{A}₀) ratio from the (I^{B}ₘₐₓ)/(I^{B}₀) ratio for Example 1 to Example 13.

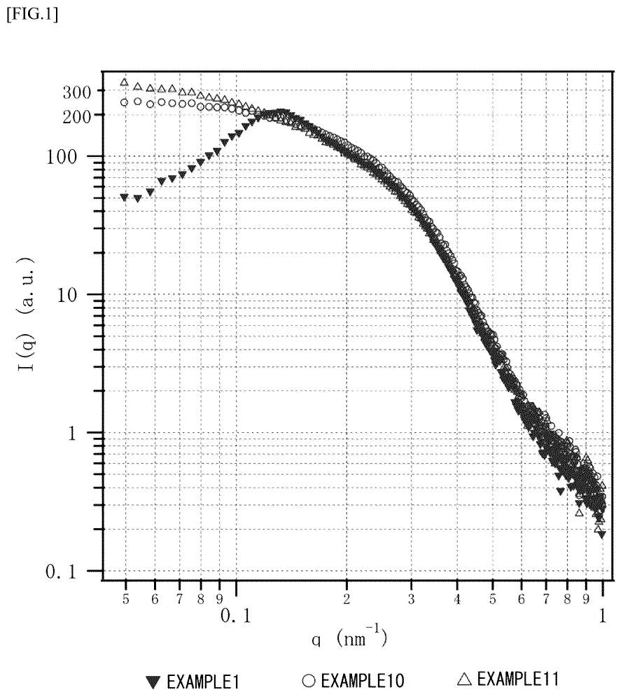

FIG. 1 shows the results of small-angle X-ray scattering measurement of the silica sols obtained in Example 1, Example 10, and Example 11. The horizontal axis represents scattering vector (q), and the vertical axis represents scattering intensity (I).

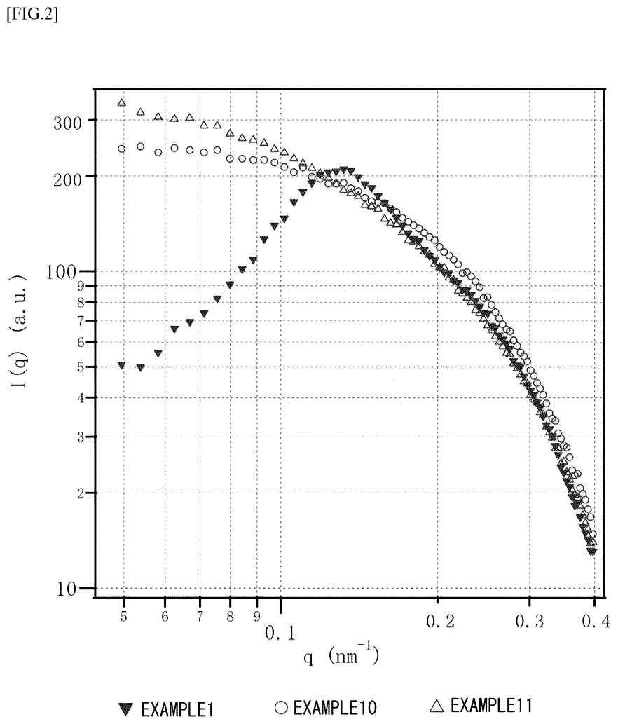

FIG. 2 is an enlarged view of the results.

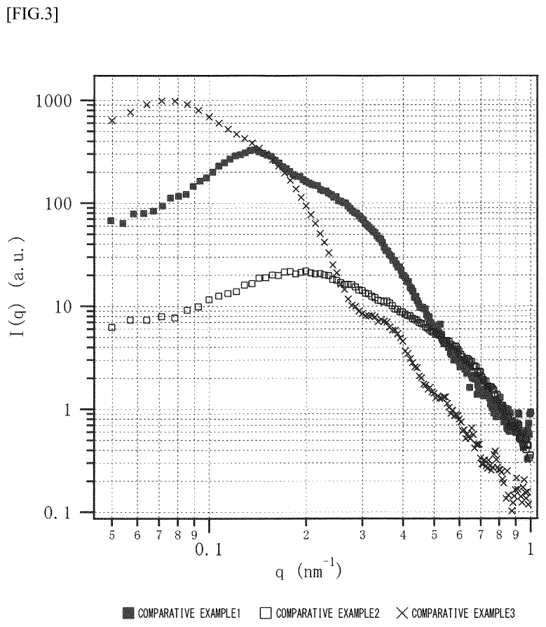

FIG. 3 shows the results of small-angle X-ray scattering measurement of silica sols obtained in Comparative Example 1, Comparative Example 2, and Comparative Example 3. The horizontal axis represents scattering vector (q), and the vertical axis represents scattering intensity (I).

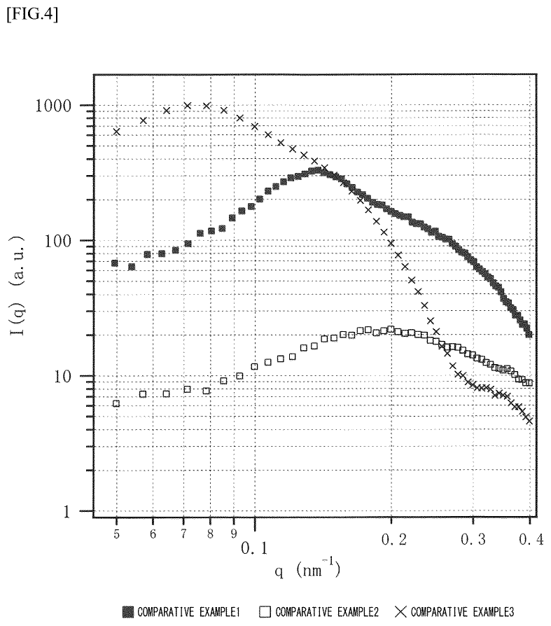

FIG. 4 is an enlarged view of the results.

The salt resistance of the sample was evaluated by the HAZE value after storage at 20° C. for 24 hours and the change over time indicated by the particle diameter (DLS change) value determined by a dynamic light scattering method.

That is, regarding the HAZE value of the silica sol using salt water with a salt concentration of 4% by mass as a dispersion medium and with a silica particle concentration of 0.1% by mass, the HAZE value (progressive HAZE value) after storage at 20° C. for 24 hours from the time of production is shown in the following tables.

In addition, regarding the particle diameter of the silica sol using salt water with a salt concentration of 4% by mass as a dispersion medium and with a silica particle concentration of 0.1% by mass determined by a dynamic light scattering method, the increase (DLS change) in the value (progressive DLS diameter) after storage for 24 hours relative to the initial value (initial DLS diameter) within 12 hours from the time of production is shown in the following tables.

Here, the unit of the scattering intensity (I) is (a.u.).

TABLE 1

| | Example 1 | Example 2 | Example 3 | Example 4 | Example 5 |
|---|---|---|---|---|---|
| (I^{A}ₘₐₓ) | 210 | 288 | 219 | 214 | 352 |
| (I^{A}₀) | 51 | 288 | 208 | 193 | 352 |
| (I^{A}ₘₐₓ)/(I^{A}₀) | 4.1 | 1.0 | 1.1 | 1.1 | 1.0 |
| (I^{B}ₘₐₓ)/(I^{B}₀) − (I^{A}ₘₐₓ)/(I^{A}₀) | 0.7 | 3.8 | 3.7 | 3.7 | 3.8 |
| Progressive HAZE value | 0 | 0 | 0 | 0 | 0 |
| Initial DLS diameter [nm] | 23.5 | 22.8 | 22.3 | 24.7 | 23.9 |
| Progressive DLS diameter [nm] | 22.5 | 31.8 | 21.1 | 27.9 | 26.2 |
| DLS change | 1.0 | 1.4 | 0.9 | 1.1 | 1.1 |

TABLE 2

| | Example 6 | Example 7 | Example 8 | Example 9 |
|---|---|---|---|---|
| (I^{A}ₘₐₓ) | 233 | 323 | 221 | 218 |
| (I^{A}₀) | 193 | 323 | 66 | 218 |
| (I^{A}ₘₐₓ)/(I^{A}₀) | 1.2 | 1.0 | 3.3 | 1.0 |
| (I^{B}ₘₐₓ)/(I^{B}₀) − (I^{A}ₘₐₓ)/(I^{A}₀) | 3.6 | 3.8 | 1.5 | 3.8 |
| Progressive HAZE value | 0 | 3.06 | 3.67 | 4.72 |
| Initial DLS diameter [nm] | 24.5 | 31.7 | 32.4 | 36.0 |
| Progressive DLS diameter [nm] | 26.3 | 140 | 158 | 31.8 |
| DLS change | 1.1 | 4.4 | 4.9 | 0.9 |

TABLE 3

| | Example 10 | Example 11 | Example 12 | Example 13 |
|---|---|---|---|---|
| (I^{A}ₘₐₓ) | 247 | 338 | 21 | 515 |
| (I^{A}₀) | 243 | 338 | 18 | 505 |
| (I^{A}ₘₐₓ)/(I^{A}₀) | 1.0 | 1.0 | 1.2 | 1.0 |
| (I^{B}ₘₐₓ)/(I^{B}₀) − (I^{A}ₘₐₓ)/(I^{A}₀) | 3.8 | 3.8 | 2.3 | 0.6 |
| Progressive HAZE value | 3.90 | 0.05 | 0 | 0 |
| Initial DLS diameter [nm] | 34.5 | 38.5 | 25.8 | 46.1 |
| Progressive DLS diameter [nm] | 172 | 49.7 | 60.9 | 49.7 |
| DLS change | 5.0 | 1.3 | 2.4 | 1.1 |

TABLE 4

| | Comparative | Comparative | Comparative |
|---|---|---|---|
| | Example 1 | Example 2 | Example 3 |
| (I^{B}ₘₐₓ) | 329 | 22 | 989 |
| (I^{B}₀) | 68 | 6.2 | 637 |
| (I^{B}ₘₐₓ)/(I^{B}₀) | 4.8 | 3.5 | 1.6 |
| Progressive HAZE value | 5.60 | 0.42 | 70.58 |
| Initial DLS diameter [nm] | 37.1 | 21.6 | 1193 |
| Progressive DLS | 191.1 | 96.8 | 2315 |
| diameter [nm] | | | |
| DLS change | 5.2 | 4.5 | 1.9 |

Since the additive-containing silica sols of Example 1 to Example 11 satisfied Formula (2) and Formula (3), the progressive HAZE value was lower and the DLS change was smaller than those of the silica sol containing no additive of Comparative Example 1. Similarly, since the additive-containing silica sol of Example 12 satisfied Formula (2) and Formula (3), the progressive HAZE value was lower and the DLS change was smaller than those of the silica sol containing no additive of Comparative Example 2, and since the additive-containing silica sol of Example 13 satisfied Formula (2) and Formula (3), the progressive HAZE value was lower and the DLS change was smaller than those of the silica sol containing no additive of Comparative Example 3.

### INDUSTRIAL APPLICABILITY

When the scattering intensity (I) of the additive-containing silica sol as a function of a specific scattering vector determined by a small-angle scattering method using X-rays satisfies specific conditions, a stable silica sol can be obtained. The silica sol has high stability particularly when the dispersion medium is a highly electrolytic medium such as an aqueous medium with a pH of 1 to 10, for example, a pH of 1 to 6, an aqueous medium with a pH of 8 to 10, and salt water with a salt concentration of 0.1% by mass to 4.0% by mass, and a polar organic solvent, and can be applied in fields in which such dispersion media are used.

1. An additive-containing silica sol in which a scattering intensity (I) of the additive-containing silica sol as a function of scattering vector (q) determined by a small-angle scattering method using X-rays satisfies the following Formula (2) and Formula (3):
$$0.1 \leq ( {I}_{m ax}^{B} ) / ( {I}_{0}^{B} ) - ( {I}_{m ax}^{A} ) / ( {I}_{0}^{A} ) \leq 4.8 \qquad Formula ( 2 )$$
$$1 \leq ( {I}_{m ax}^{A} ) / ( {I}_{0}^{A} ) \qquad For mula ( 3 )$$
in Formula (2) and Formula (3),
I^{B}₀ is a scattering intensity when scattering vector (q) nm⁻¹ of the silica sol is 0.05 if a silica particle concentration in the silica sol before an additive is added is 3.5% by mass,
I^{B}ₘₐₓ is a scattering intensity when the scattering vector (q) nm⁻¹ of the silica sol is a maximum value if the silica particle concentration in the silica sol before the additive is added is 3.5% by mass,
I^{A}₀ is a scattering intensity when the scattering vector (q) nm⁻¹ of the silica sol is 0.05 if the silica particle concentration in the silica sol after the additive is added is 3.5% by mass, and
I^{A}ₘₐₓ is a scattering intensity when the scattering vector (q) nm⁻¹ of the silica sol is a maximum value if the silica particle concentration in the silica sol after the additive is added is 3.5% by mass.

2. The silica sol according to claim 1,
wherein, regarding a HAZE value of a silica sol using salt water with a salt concentration of 4% by mass as a dispersion medium and with a silica particle concentration of 0.1% by mass, the HAZE value of the silica sol after storage at 20° C. for 24 hours from a time of production is lower than the HAZE value of the silica sol before the additive is added after storage at 20° C. for 24 hours from a time of production.

3. The silica sol according to claim 1,
wherein, regarding a particle diameter of the silica sol using salt water with a salt concentration of 4% by mass as a dispersion medium and with a silica particle concentration of 0.1% by mass, a ratio of the particle diameter determined by a dynamic light scattering method after storage at 20° C. for 24 hours to the particle diameter determined by the dynamic light scattering method during production is lower than a ratio of the particle diameter determined by the dynamic light scattering method after storage at 20° C. for 24 hours to the particle diameter determined by the dynamic light scattering method during production in the silica sol before the additive is added.

4. The silica sol according to claim 1,
wherein the additive is an antioxidant substance.

5. The silica sol according to claim 1,
wherein the additive is a hydrolyzable silane, a sugar, an organic acid or salt of the organic acid, a sulfite, a thiocyanate, a mercapto organic acid or salt of the mercapto organic acid, a surfactant, or a polyhydroxy compound.

6. The silica sol according to claim 5,
wherein the hydrolyzable silane has a structure of the following Formula (1):
$${R}_{a}^{1} {Si ( {R}^{2} )}_{4 - a} \qquad Formula ( 1 )$$
(in Formula (1), each of R is an organic group having a cationic functional group or an organic group having an anionic functional group and is bonded to a silicon atom through an Si—C bond, each of R² is an alkoxy group, an acyloxy group, or a halogen atom, and a is an integer of 1 to 3).

7. The silica sol according to claim 6,
wherein the cationic functional group is an amino group.

8. The silica sol according to claim 6,
wherein the anionic functional group is a glycidoxy group.

9. The silica sol according to claim 5,
wherein the sugar is sorbitol, glucose, or arabinose.

10. The silica sol according to claim 5,
wherein the organic acid or the salt of the organic acid is gluconic acid, lactic acid, or thioglycolic acid or salt of the gluconic acid, the lactic acid, or the thioglycolic acid.

11. The silica sol according to claim 5,
wherein the sulfite is pyrosulfite.

12. The silica sol according to claim 5,
wherein the thiocyanate is sodium thiocyanate.

13. The silica sol according to claim 5,
wherein the mercapto organic acid or the salt of the mercapto organic acid is a mercaptoacetic acid or ammonium salt of the mercaptoacetic acid.

14. The silica sol according to claim 5,
wherein the surfactant is at least one selected from the group consisting of an anionic surfactant, a cationic surfactant, an amphoteric surfactant, and a nonionic surfactant, and is a surfactant including at least an anionic surfactant, a nonionic surfactant, or both of the anionic surfactant and the nonionic surfactant.

15. The silica sol according to claim 5,
wherein the polyhydroxy compound is ascorbic acid.

16. The silica sol according to claim 1,
wherein the dispersion medium of the silica sol is an aqueous medium with a pH of 1 to 10, salt water with a salt concentration of 0.1 to 4.0% by mass, or an organic solvent.

17. A method for producing the additive-containing silica sol according to claim 1, the method comprising
a step of adding an additive to a silica sol and adjusting a scattering intensity (I) of the additive-containing silica sol as a function of scattering vector (q) determined by a small-angle scattering method using X-rays so that the scattering intensity (I) satisfies the following Formula (2) and Formula (3):
$$0.1 \leq ( {I}_{m ax}^{B} ) / ( {I}_{0}^{B} ) - ( {I}_{m ax}^{A} ) / ( {I}_{0}^{A} ) \leq 4.8 \qquad Formula ( 2 )$$
$$1 \leq ( {I}_{m ax}^{A} ) / ( {I}_{0}^{A} ) \qquad For mula ( 3 )$$
in Formula (2) and Formula (3),
I^{B}₀ is a scattering intensity when scattering vector (q) nm⁻¹ of the silica sol is 0.05 if a silica particle concentration in the silica sol before the additive is added is 3.5% by mass,
I^{B}ₘₐₓ is a scattering intensity when the scattering vector (q) nm⁻¹ of the silica sol is a maximum value if the silica particle concentration in the silica sol before the additive is added is 3.5% by mass,
I^{A}₀ is a scattering intensity when the scattering vector (q) nm⁻¹ of the silica sol is 0.05 if the silica particle concentration in the silica sol after the additive is added is 3.5% by mass, and
I^{A}ₘₐₓ is a scattering intensity when the scattering vector (q) nm⁻¹ of the silica sol is a maximum value if the silica particle concentration in the silica sol after the additive is added is 3.5% by mass.
